(19) United States
(12) Patent Application Publication
(10) Pub. No.: US 2023/0051821 A1
(43) Pub. Date: Feb. 16, 2023

(54) DETERMINING A STATE OF A PNT-BASED TIMING SIGNAL

(71) Applicant: Microchip Technology Incorporated, Chandler, AZ (US)

(72) Inventors: Ed Ossi, Boulder, CO (US); Greg Wolff, Broomfield, CO (US); Lars Boehinke, Longmont, CO (US)

(21) Appl. No.: 17/662,975

(22) Filed: May 11, 2022

Related U.S. Application Data
(60) Provisional application No. 63/186,947, filed on May 11, 2021.

(51) Int. Cl. G01S 19/21; G01S 19/05; G01S 19/25

(52) U.S. Cl. CPC G01S 19/215; G01S 19/05; G01S 19/256

(57) ABSTRACT

Some examples disclosed herein include a method. The method may include determining a relationship between a property of a position, navigation, and timing (PNT)-based timing signal and a property of a virtual time source. The method may also include determining a state of the PNT-based timing signal at least partially responsive to the determined relationship. The method may also include one or more of: providing the PNT-based timing signal at least partially responsive to determining that the state of the PNT-based timing signal corresponds to a first state, disregarding the PNT-based timing signal at least partially responsive to determining that the state of the timing signal corresponds to a second state, and providing an indication of the state of the PNT-based timing signal at least partially responsive to determining that the state of the timing signal corresponds to a second state. Related devices, systems and methods are also disclosed.

### CROSS-REFERENCE TO RELATED APPLICATIONS

This application claims the benefit of the priority date of U.S. Provisional Patent Application No. 63/186,947, filed May 11, 2021, and titled “USING NETWORK-BASED TIMING TO SECURE POSITIONING, NAVIGATION AND TIMING (PNT) SITES,” the disclosure of which is incorporated herein in its entirety by this reference.

### FIELD

This description relates, generally, to determining a state of a timing signal. More specifically, some examples relate to determining whether timing signals exhibits an anomaly, without limitation. Related methods, systems, and apparatuses are also disclosed.

### BACKGROUND

Global Positioning Systems (GPS) and Global Navigation Satellite Systems (GNSS) include satellites that broadcast signals and receivers that receive the broadcasted signals. GPS or GNSS receivers solve for position and time by receiving at least four signals and solving for position (latitude, longitude, and elevation) and time. The signals are space-based, low-power and unencrypted making them susceptible to both intentional and unintentional disruption. Inexpensive GPS and GNSS jammers and spoofers have raised vulnerability concerns, especially for critical infrastructure, key resource, and safety of life applications.

### BRIEF DESCRIPTION THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a functional block diagram illustrating an example apparatus according to one or more examples.

FIG. 2 is a functional block diagram illustrating another example system according to one or more examples.

FIG. 3 is a functional block diagram illustrating another example system according to one or more examples.

FIG. 4 is a functional block diagram illustrating another example system according to one or more examples.

FIG. 5 is a flowchart of an example method, according to one or more examples.

FIG. 6 is a flowchart of example method steps, according to one or more examples.

FIG. 7 illustrates a block diagram of an example device that may be used to implement various functions, operations, acts, processes, and/or methods, in accordance with one or more examples.

FIG. 8 is a functional block diagram illustrating another example system according to one or more examples.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are only examples and should not be construed as the only way to implement the present disclosure unless specified otherwise herein. Additionally, block definitions and partitioning of logic between various blocks is an example of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. As a non-limiting example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Because it is possible to spoof position, navigation, and timing (PNT) signals, (e.g., GPS and GNSS signals, without limitation) (e.g., by broadcasting a false signal that may be more powerful than a true signal at a receiver, without limitation), it may be valuable to validate PNT signals. As a non-limiting example, it may be valuable to validate a PNT signal by validating a timing signal, which timing signal is based on the PNT signal at a receiver. The term “based on,” as used herein with respect to a timing signal based on a PNT signal, is synonymous with the term derived from, or obtained from, and may be used interchangeably. For example, a PNT-based timing signal may including timing information that may be derived from a PNT signal e.g., as received at an antenna.

Generally, validating a PNT signal, e.g., validating a timing signal based on the PNT signal, may include determining a relationship between a property of the timing signal and a property of a virtual time source. If the property of the timing signal has a specified relationship to the property of the virtual time source, the timing signal may be validated, and as a result the PNT signal, inter-alia, may be validated. In contrast, if the property of timing signal does not have the specified relationship to the property of the virtual time source, the PNT signal may be determined to exhibit an anomaly or to be invalid.

The property of each of the timing signal and the virtual time source may be a respective top of second. In the present disclosure, the term “top of second” may refer to a beginning of a second. As a non-limiting example, the timing signal based on the PNT signal may include an indication of time. The indication of time may be accurate to fractions of seconds. The indication of time may include indications of beginnings of seconds e.g., tops of seconds, without limitation. A timing signal based on the PNT signal may include tops of seconds, which tops of seconds may be indications of tops of seconds according to the PNT signal. Likewise, the virtual time source may include indications of tops of seconds e.g., beginnings of seconds. A timing signal based on the virtual time source may include tops of seconds, which tops of seconds may be indications of tops of seconds according to the virtual time source. A comparison between tops of seconds of the timing signal based on the PNT signal and tops of seconds of the virtual time source, or of the timing signal based on the virtual time source, may be indicative of a degree of temporal alignment between the timing signal based on the PNT signal and the virtual time source. A comparison between tops of seconds of the timing signal based on the PNT signal and tops of seconds of the virtual time source may include a comparison between tops of seconds of the timing signal based on the PNT signal and either tops of seconds of the virtual time source or tops of seconds of a timing signal based on the virtual time source.

The specified relationship between the timing signal based on the PNT signal and the virtual time source upon which a determination of validity may be based may be temporal alignment. As a non-limiting example, if the timing signal based on the PNT signal is temporally aligned with the virtual time source (or the timing signal based on the virtual time source), it may be determined that the PNT signal is valid. In contrast, if the timing signal based on the PNT signal is not temporally aligned with the virtual time source (or the timing signal based on the virtual time source), it may be determined that the PNT signal exhibits an anomaly or is invalid. Temporal alignment may be a matter of degrees and, in some examples, there may be thresholds for determining when the timing signal based on the PNT signal is temporally aligned with the virtual time source. As a non-limiting example, temporal alignment may be defined as less than a microsecond, less than 100 nanoseconds, or less than another threshold (without limitation) difference between tops of seconds of the timing signal based on the PNT signal and the tops of seconds of the virtual time source (or the timing signal based on the virtual time source).

In the present disclosure, the term “virtual time source” may refer to a timing signal that is assumed to be a valid timing signal by a device that will use or rely on the virtual time source. In some examples, a virtual time source may be generated based on a received timing signal, or on a trusted clock, which received timing signal, or trusted clock is remote from the device that will use or rely on the virtual time source. For example, the virtual time source may be generated (e.g., at the remote device) based on an atomic clock or based on trusted PNT signals, and network-transferred to the device that will use or rely on the virtual time source. The network-transferred virtual time source may be transferred according to one or more network-based-timing protocols (e.g., Institute of Electrical and Electronics Engineers (IEEE) 1588, without limitation). Additionally or alternatively, a virtual time source may include an indication of whether the virtual time source is valid or invalid (e.g., whether the virtual time source is to be trusted or not).

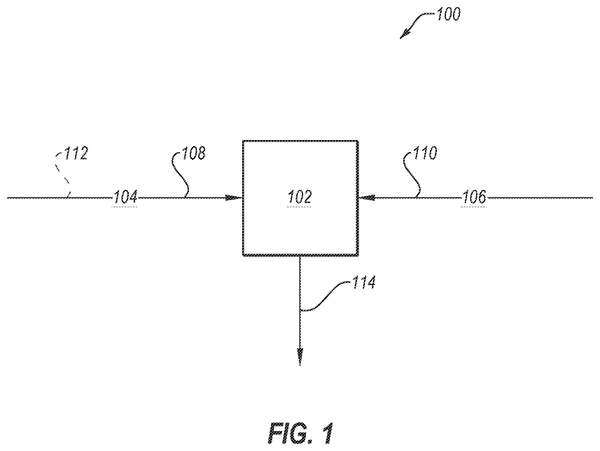

FIG. 1 is a functional block diagram illustrating an apparatus 100 in accordance with one or more examples. Apparatus 100 may include detector 102 to assert an anomaly indication 114 that invalidates PNT signal 104 (e.g., detector 102 determines whether PNT signal 104 exhibits an anomaly 112, without limitation) based on a relationship between top of second 108 of a timing signal based on the PNT signal 104 and top of second 110 of virtual time source 106.

As a non-limiting example, detector 102 may detect a presence of an anomaly 112 in PNT signal 104 at least in part by sensing a difference between top of second 110 of virtual time source 106 and top of second 108 of timing signal based on the PNT signal 104. In one or more examples, apparatus 100 infers a presence of anomaly 112 at least partially responsive to a sensed difference between top of second 110 of virtual time source 106 and top of second 108 of a timing signal based on the PNT signal 104.

In one or more examples, assertion of anomaly indication 114 may indicate a presence of an anomaly 112 and that PNT signal 104 is not valid. De-assertion of anomaly indication 114 may indicate no presence of an anomaly 112 and that PNT signal 104 is valid. While FIG. 1 depicts anomaly 112 for ease of discussion, the presence of anomaly 112 is not required as various apparatuses in accordance with various examples may detect valid PNT signals 104, invalid PNT signals 104, or both valid and invalid PNT signals 104. The fact that the anomaly 112 may or may not be present in PNT signal 104 is indicated by anomaly 112 being illustrated using a dashed lead line. Similarly, other anomalies are illustrated using dashed lead lines.

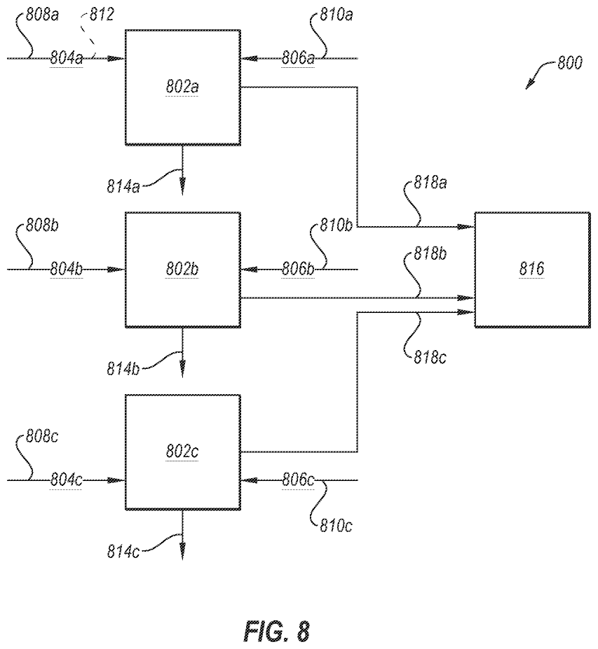

FIG. 8 is a functional block diagram illustrating a system 800 in accordance with one or more examples. System 800 includes three detectors 802 that each may detect validity of a PNT signal. In FIG. 8, three detectors are illustrated for descriptive purposes. Other examples may include any number of detectors 802.

In particular, system 800 includes detector 802a to assert an anomaly indication 814a that invalidates PNT signal 804a based on a relationship between top of second 808a of PNT signal 804a and top of second 810a of virtual time source 806a, detector 802b to assert an anomaly indication 814b that invalidates PNT signal 804b based on a relationship between top of second 808b of PNT signal 804b and top of second 810b of virtual time source 806b, and detector 802c to assert an anomaly indication 814c that invalidates PNT signal 804c based on a relationship between top of second 808c of PNT signal 804c and top of second 810c of virtual time source 806c.

Each of detector 802a, detector 802b, and detector 802c may be an example of detector 102 of FIG. 1. One or more of detector 802a, detector 802b, and detector 802c may be collocated. Alternatively, all of detector 802a, detector 802b, and detector 802c may be at different locations.

Each of PNT signal 804a, PNT signal 804b, and PNT signal 804c, may be an instance of the same PNT signal as received at detector 802a, detector 802b, and detector 802c respectively. For example, each of PNT signal 804a, PNT signal 804b, and PNT signal 804c may have been broadcast by the same source or by two or more different sources. Additionally or alternatively, each of PNT signal 804a, PNT signal 804b, and PNT signal 804c may be an example of PNT signal 104 of FIG. 1.

Each of virtual time source 806a, virtual time source 806b, and virtual time source 806c may be based on the same timing signal as received at detector 802a, detector 802b, and detector 802c respectively. For example, each of virtual time source 806a, virtual time source 806b, and virtual time source 806c may be based on network-based timing signal that may be received by each of detector 802a, detector 802b, and detector 802c respectively.

In the example illustrated in FIG. 8, PNT signal 804a exhibits anomaly 812. (For example, a spoofer may have generated PNT signal 804a but only detector 802a may be in range to receive the spoofed signal.) Detector 802a may determine that PNT signal 804a exhibits anomaly 812 (or that PNT signal 804a is invalid) based on a difference between top of second 808a and top of second 810a. Based on the determination that PNT signal 804a exhibits anomaly 812 (or that PNT signal 804a is invalid), detector 802a may assert anomaly indication 814a and send validity report 818a to analyzer 816 for further analysis. In contrast, detector 802b may determine that PNT signal 804b does not exhibit an anomaly (or that PNT signal 804b is valid) based on a temporal correspondence between top of second 808b and top of second 810b. Based on the determination that PNT signal 804b does not exhibit an anomaly (or that PNT signal 804b is valid) detector 802b may send validity report 818b to analyzer 816. Similarly, detector 802c may determine that PNT signal 804c does not exhibit an anomaly (or that PNT signal 804c is valid) based on a temporal correspondence between top of second 808c and top of second 810c. Based on the determination that PNT signal 804c does not exhibit an anomaly (or that PNT signal 804c is valid) detector 802c may send validity report 818c to analyzer 816. Analyzer 816 may receive the validity reports 818a, 818b and 818c, and may identify a spoofing attempt based on one, or more, of validity reports 818a, 818b and 818c.

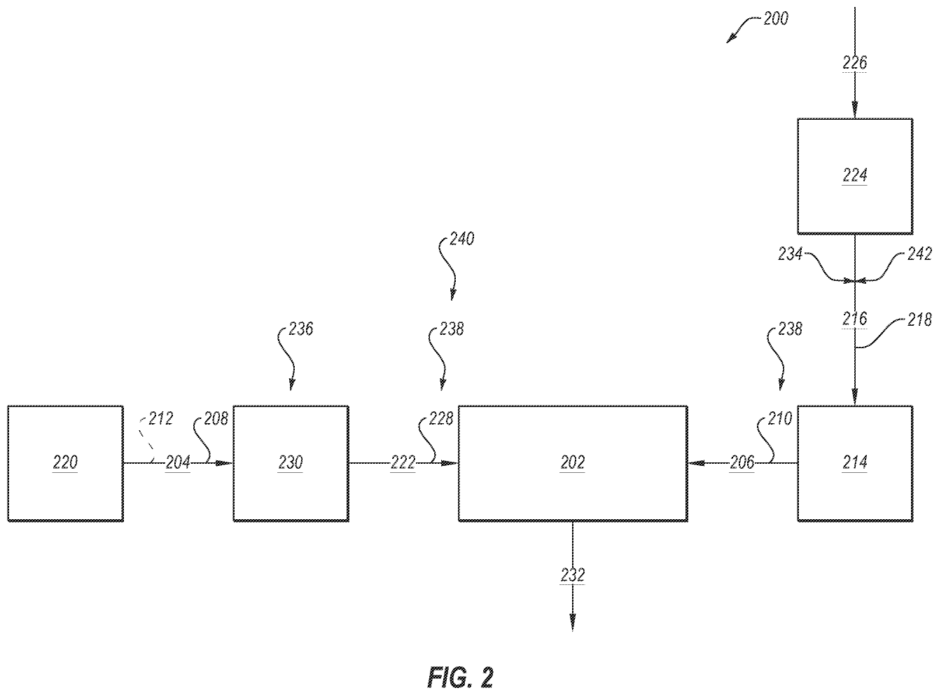

FIG. 2 is a functional block diagram illustrating a system 200 in accordance with one or more examples. System 200 may include detector 202 to assert an anomaly indication 232, timing-signal generator 214, and virtual-time-source generator 224. Virtual-time-source generator 224 may generate virtual time source 216 (including top of second 218) based on truth signal 226 (which truth signal 226 may be, as a non-limiting example, an atomic clock or a trusted PNT signal. Virtual time source 216 may be a signal transferred by virtual-time-source generator 224 to timing signal generator 214 according to a network-based-timing protocol 234. Timing-signal generator 214 may generate timing signal 206 (including top of second 210) based on virtual time source 216 (including top of second 218). PNT-based timing signal generator 230 may receive PNT signal 204 from GPS or GNSS constellation 220 (or from a spoofer imitating GPS or GNSS constellation 220). PNT signal 204 may, in some cases, exhibit anomaly 212. PNT-based timing signal generator 230 may generate PNT-based timing signal 222 (including top of second 228) based on PNT signal 204.

Timing-signal generator 214 may generate timing signal 206, which may include top of second 210, which may be indicative of top of second 218 of virtual time source 216. Top of second 210 may be indicative of a beginning of a second according to Universal Coordinated Time (UTC) 242 as derived from virtual time source 216. In some examples, timing signal 206 may be a digital signal in which a leading edge is indicative of a top of second 218. In such examples, each leading edge of timing signal 206 may be a top of second 210 indicative of a top of second 218 of virtual time source 216.

Detector 202 may be the same as, substantially similar to, or perform some of the same operations as detector 102 of FIG. 1, or detector 802 of FIG. 8. PNT-based timing signal 222 may include top of second 228 derived from PNT signal 204. Top of second 208 may be indicative of a beginning of a second according to UTC as derived from PNT signal 204. In some examples, PNT-based timing signal 222 may be a digital signal in which a leading edge is indicative of a top of second 208. In such examples, each leading edge of PNT-based timing signal 222 may be a top of second 228 derived from PNT signal 204.

In some cases, PNT-based timing signal generator 230 may generate PNT-based timing signal 222 (including top of second 228) based on receiving multiple (e.g., four or more, without limitation) PNT signals 204 from multiple (e.g., four or more, without limitation) GPS or GNSS constellation 220 space vehicles and calculating a position 236 of PNT-based timing signal generator 230 responsive to the four or more PNT signals 204. Position 236 of PNT-based timing signal generator 230 may be used to generate PNT-based timing signal 222 from PNT signals 204. As a non-limiting example, a time delay (based on position 236 of PNT-based timing signal generator 230 and a position of a transmitter of a respective PNT signal 204) may be applied to a broadcast time of the PNT signal 204 to generate PNT-based timing signal 222. Because PNT-based timing signal 222 may be based on multiple (e.g., four or more, without limitation) PNT signals 204, the validity of PNT-based timing signal 222 may be indicative of the validity of one or more of the multiple PNT signals 204. For example, if detector 202 validates PNT-based timing signal 222, detector 202 may validate all of the PNT signals 204 on which PNT-based timing signal 222 is based. All of the PNT signals 204 may be validated, as PNT-based timing signal generator 230 calculates position and time of PNT-based timing signal 222 simultaneously (latitude, longitude, elevation, and time) based on the PNT signals 204. Each PNT signal 204 contributes to top of second 228. If one PNT signal 204 is spoofed, the resultant PNT-based timing signal 222, and top of second 228, will be skewed. If latitude, longitude, and elevation of PNT-based timing signal generator 230 is already known, then PNT-based timing signal generator 230 can solve for the time and determine the PNT signal 204 that is spoofed.

Detector 202 may compare timing signal 206 to PNT-based timing signal 222 to determine whether PNT-based timing signal 222 is valid. As a non-limiting example, if top of second 228 of PNT-based timing signal 222 exhibits a temporal correspondence 238 with top of second 210 of timing signal 206 (which is indicative of top of second 218 of virtual time source 216), detector 202 may determine that PNT-based timing signal 222 is valid. Temporal correspondence 238 may be based on a threshold duration 240. As a non-limiting example, if top of second 228 of PNT-based timing signal 222 is within threshold duration 240 from top of second 210 of timing signal 206, detector 202 may determine that PNT-based timing signal 222 is valid. Alternatively, if top of second 228 is not within threshold duration 240 from top of second 210, detector 202 may determine that PNT-based timing signal 222 is invalid. Because PNT-based timing signal 222 is based on PNT signal 204, validating PNT-based timing signal 222 may be related to validating PNT signal 204. For example, by validating PNT-based timing signal 222, detector 202 may implicitly validate PNT signal 204. Additionally or alternatively, responsive to validating PNT-based timing signal 222, detector 202 may validate PNT signal 204.

In some examples, in response to determining whether PNT-based timing signal 222 is valid, detector 202 may perform one or more processes. As a non-limiting example, in response to determining that PNT-based timing signal 222 is valid, detector 202 may provide PNT signal 204, or PNT-based timing signal 222, or both, e.g., to another system or device, without limitation. As another example, in response to determining that PNT-based timing signal 222 is invalid, detector 202 may disregard PNT signal 204 or PNT-based timing signal 222, or both, or assert anomaly indication 232, which anomaly indication 232 may be an indication that PNT signal 204 is invalid.

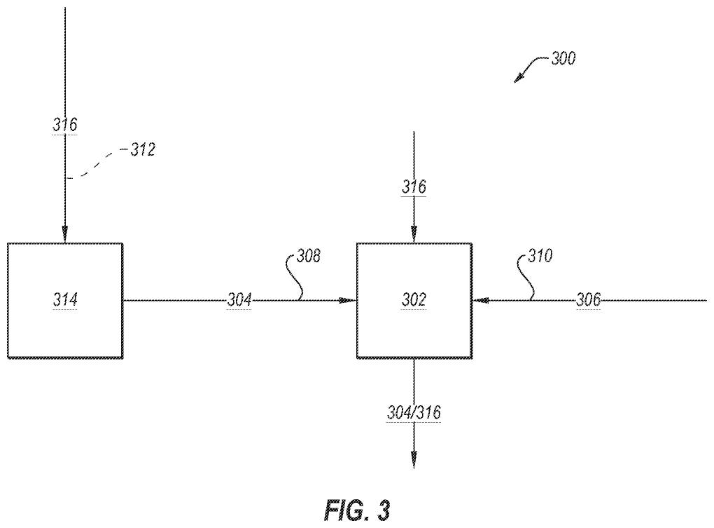

FIG. 3 is a functional block diagram illustrating a system 300 in accordance with one or more examples. System 300 includes detector 302 and receiver 314. Receiver 314 may generate PNT-based timing signal 304 (including property 308) at least partially responsive to PNT signal 316, which PNT signal 316 may exhibit an anomaly 312. Detector 302 may receive virtual time source 306 (including property 310). Detector 302 may selectively provide PNT-based timing signal 304, or PNT signal 316, or both, e.g., to another system or device, without limitation.

Property 308 may be indicative of a beginning of a second, i.e. a top of second, according to UTC as derived from PNT signal 316. In some examples, PNT-based timing signal 304 may be a digital signal in which a leading edge is indicative of a top of second. In such examples, each leading edge of PNT-based timing signal 304 may be a property 308 indicative of a top of second of PNT-based timing signal 304.

Property 310 may be indicative of a beginning of a second according to Universal Coordinated Time (UTC) as represented by virtual time source 306. In some examples, virtual time source 306 may be a digital signal in which a leading edge is indicative of a top of second. In such examples, each leading edge of virtual time source 306 may be a property 310 indicative of a top of second of virtual time source 306.

In some cases, receiver 314 may, in generating PNT-based timing signal 304, receive multiple (e.g., four or more, without limitation) PNT signals 316 from multiple (e.g., four or more, without limitation) respective sources and calculate a position of receiver 314 responsive to the multiple (e.g., four or more, without limitation) PNT signals 316. The position of receiver 314 may be used to generate PNT-based timing signal 304 from PNT signal 316. As a non-limiting example, a time delay (based on the position of receiver 314 and a position of a source of a PNT signal) may be applied to a broadcast time of the PNT signal to generate PNT-based timing signal 304. PNT-based timing signal 304 may be based on one or more of the PNT signals 316. Because PNT-based timing signal 304 is based on PNT signal 316, validating PNT-based timing signal 304 may be related to validating PNT signal 316. For example, by validating PNT-based timing signal 304, detector 302 may implicitly validate PNT signal 316. Additionally or alternatively, responsive to validating PNT-based timing signal 304, detector 302 may validate PNT signal 316.

Detector 302 may determine a relationship between property 308 of PNT-based timing signal 304 and property 310 of virtual time source 306. Each of property 308 and property 310 may be a respective top of second. The relationship may be based on whether tops of seconds of PNT-based timing signal 304 are temporally aligned with tops of seconds of virtual time source 306.

Detector 302 may determine a state of PNT-based timing signal 304 at least partially responsive to the determined relationship. The state may be related to a validity of PNT signal 316 or PNT-based timing signal 304 or whether PNT signal 316 exhibits anomaly 312. As a non-limiting example, if the tops of seconds of PNT-based timing signal 304 are temporally aligned with the tops of seconds of virtual time source 306, it may be determined that the PNT-based timing signal 304, PNT signal 316, or both are valid. In contrast, if the tops of seconds of PNT-based timing signal 304 are not temporally aligned with the tops of seconds of virtual time source 306, it may be determined that one or both of PNT-based timing signal 304 is invalid or the PNT signal 316 exhibits anomaly 312 or is invalid.

Detector 302 may perform a process at least partially responsive to the determined state of PNT-based timing signal 304. As an example of performing a process, detector 302 may provide PNT-based timing signal 304, PNT signal 316, or both at least partially responsive to determining that the state of the timing signal corresponds to a first state (e.g., determining that timing signal 304 is valid, without limitation). As another example of performing a process, detector 302 may disregard PNT-based timing signal 304, PNT signal 316, or both at least partially responsive to determining that the state of timing signal 304 corresponds to a second state (e.g., determining that PNT-based timing signal 304 is invalid, without limitation). As another example of performing a process, detector 302 may assert a signal indicative that PNT-based timing signal 304, PNT signal 316, or both are invalid at least partially responsive to determining that the state of PNT-based timing signal 304 corresponds to the second state.

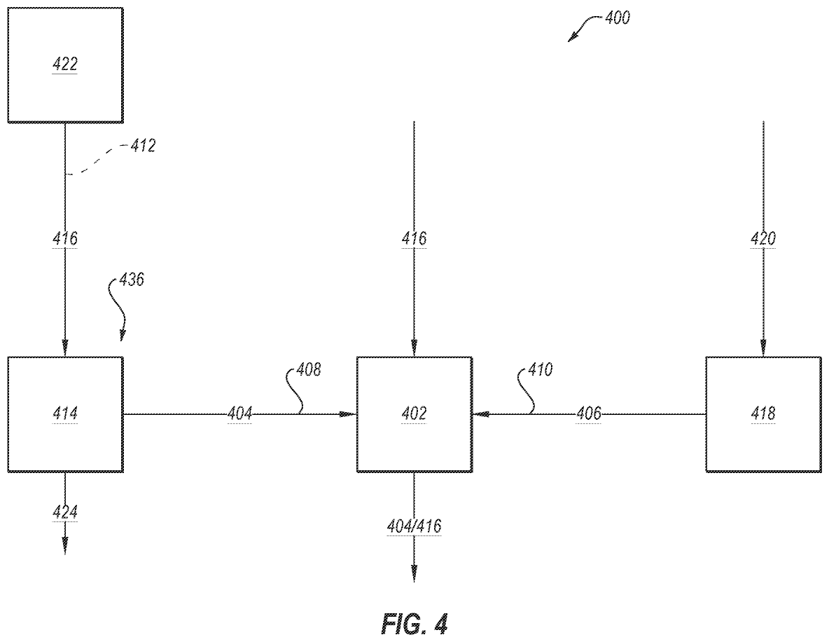

FIG. 4 is a functional block diagram illustrating a system 400 in accordance with one or more examples. System 400 includes detector 402, receiver 414, and network-connected device 418. Receiver 414 may receive PNT signal 416 (which PNT signal may exhibit an anomaly 412) from source 422 and may generate PNT-based timing signal 404 (including property 408) at least partially responsive to PNT signal 416. Additionally, receiver 414 may determine a position 436 (e.g., the position of receiver 414, without limitation) at least partially responsive to PNT signal 416. In some examples, receiver 414 may provide an indication 424 of the position 436. Network-connected device 418 may receive network-transferred timing signal 420 and may generate virtual time source 406 (including property 410) at least partially responsive to network-transferred timing signal 420. Detector 402 may receive virtual time source 406 and PNT-based timing signal 404. Detector 402 may selectively provide PNT signal 416 or PNT-based timing signal 404, or both.

Detector 402 may be the same as, substantially similar to, or perform some of the same operations as detector 302 of FIG. 3. Timing signal 404 may be the same as or substantially similar to timing signal 304 of FIG. 3. Virtual time source 406 may be the same as or substantially similar to virtual time source 306 of FIG. 3. Property 408 may be the same as or substantially similar to property 308 of FIG. 3. Property 410 may be the same as or substantially similar to property 310 of FIG. 3. Anomaly 412 may be the same as or substantially similar to anomaly 312 of FIG. 3. Receiver 414 may be the same as, substantially similar to, or perform some of the same operations as receiver 314 of FIG. 3. PNT signal 416 may be the same as or substantially similar to PNT signal 316 of FIG. 3.

Source 422 may associated with a PNT service. As a non-limiting example, source 422 may be, or may include one or more GPS or GNSS satellites. In some embodiments, source 422 may include multiple satellites which may each provide a respective PNT signal 416.

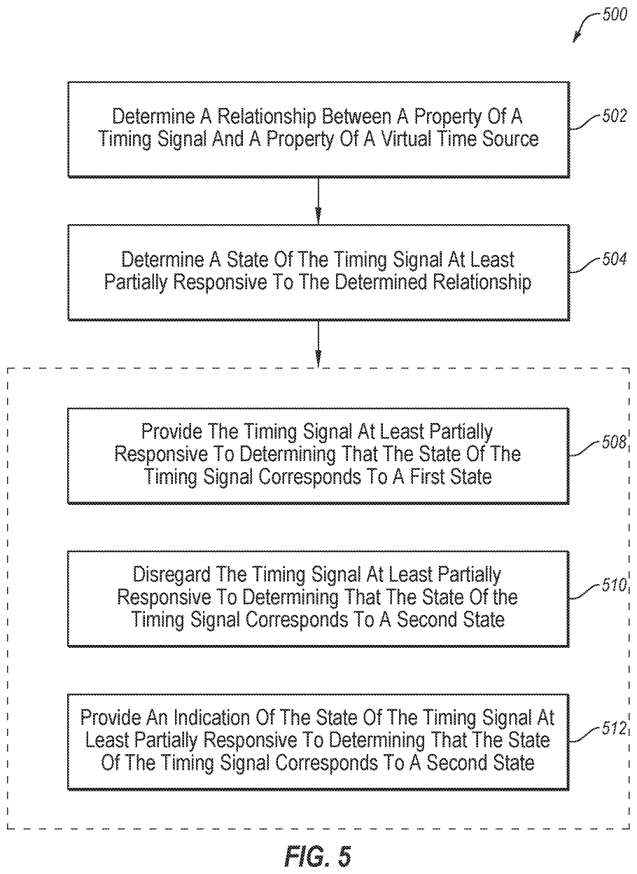

FIG. 5 is a flowchart illustrating a method 500, in accordance with one or more examples. At least a portion of method 500 may be performed, in some examples, by a device or system, such as apparatus 100 of FIG. 1, detector 102 of FIG. 1, system 200 of FIG. 2, detector 202 of FIG. 2, system 300 of FIG. 3, detector 302 of FIG. 3, system 400 of FIG. 4, detector 402 of FIG. 4, system 800 of FIG. 8, detector 802 of FIG. 8, or another device or system. Although illustrated as discrete blocks, various blocks may be divided into additional blocks, combined into fewer blocks, or eliminated, depending on the desired implementation.

In operation 502, a relationship may be determined between a property of a PNT-based timing signal and a property of a virtual time source. The property of the PNT-based timing signal may be a top of second of the PNT-based timing signal. The property of the virtual time source may be a top of second of the virtual time source. The relationship may be a temporal alignment between the top of second of the PNT-based timing signal and the top of second of the virtual time source. In some examples, at operation 502, a property of the virtual timing signal may be represented by a property of a timing signal based on the virtual time source (e.g., timing signal 206 which is based on virtual time source 216). For example, at operation 502 a virtual-time-source-based timing signal (which includes tops of seconds based on the tops of seconds of the virtual time source) may be compared with the PNT-based timing signal.

In operation 504, a state of the PNT-based timing signal may be determined at least partially responsive to the determined relationship. The state may relate to whether the PNT-based timing signal is valid or invalid. The state may be based on a degree of temporal alignment between the tops of seconds of the PNT-based timing signal and the tops of seconds of the virtual time source or between the tops of seconds of the PNT-based timing signal and the tops of seconds of the virtual-time-source-based timing signal.

One or more of operation 508, operation 510, and operation 512 may follow operation 504. The dashed-line box surrounding operation 508, operation 510, and operation 512 is to indicate that one or more of operation 508, operation 510, and operation 512 may be optional.

In operation 508, the PNT-based timing signal may be provided at least partially responsive to determining that the state of the timing signal corresponds to a first state. The first state may be a “valid” state. The timing signal may be provided to another system or device.

In operation 510, the PNT-based timing signal may be disregarded at least partially responsive to determining that the state of the timing signal corresponds to a second state. The second state may be an “invalid” state.

In operation 512, an indication of the state of the PNT-based timing signal may be provided at least partially responsive to determining that the state of the PNT-based timing signal corresponds to a second state. The second state may be an “invalid” state. The indication may indicate that the PNT-based timing signal is invalid.

Modifications, additions, or omissions may be made to method 500 without departing from the scope of the present disclosure. As a non-limiting example, the operations of method 500 may be implemented in differing order. Furthermore, the outlined operations and actions are only provided as examples, and some of the operations and actions may be optional, combined into fewer operations and actions, or expanded into additional operations and actions without detracting from the essence of the disclosed example.

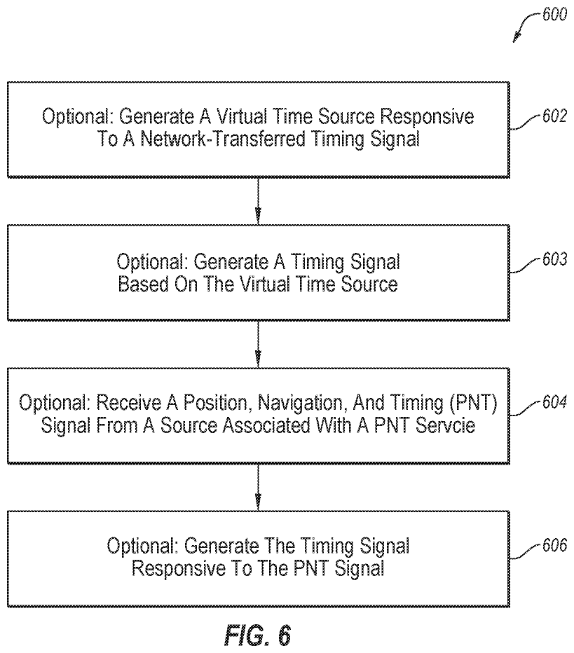

FIG. 6 is a flowchart illustrating a method steps 600, in accordance with one or more examples. At least a portion of method steps 600 may be performed, in some examples, by a device or system, such as apparatus 100 of FIG. 1, system 200, of FIG. 2, system 300 of FIG. 3, system 400 of FIG. 4, system 800 of FIG. 8, or another device or system. Although illustrated as discrete blocks, various blocks may be divided into additional blocks, combined into fewer blocks, or eliminated, depending on the desired implementation.

Method steps 600 may be part of a larger method, as a non-limiting example, in some examples, method steps 600 may be performed prior to, or as part of, method 500.

In operation 602, which is optional, a virtual time source may be generated responsive to a network-transferred timing signal. As an example, virtual-time-source generator 224 of FIG. 2 may generate virtual time source 216 of FIG. 2 responsive to truth signal 226 (which truth signal 226 may be, as a non-limiting example, a network-transferred timing signal) of FIG. 2.

In operation 608, which is optional, a timing signal based on the virtual time source may be generated. As an example, timing-signal generator 214 of FIG. 2 may generate timing signal 206 of FIG. 2 responsive to virtual time source 216 of FIG. 2.

In operation 604, which is optional, a PNT signal may be received from a source associated with a PNT service. As an example, PNT signal 416 of FIG. 4 may be received from source 422 of FIG. 4 (which may be a source associated with a PNT service).

In operation 606, which is optional, a PNT-based timing signal may be generated responsive to the PNT signal. As an example, PNT-based timing signal 404 of FIG. 4 may be generated responsive to PNT signal 416.

Modifications, additions, or omissions may be made to method steps 600 without departing from the scope of the present disclosure. As a non-limiting example, the operations of method steps 600 may be implemented in differing order. Furthermore, the outlined operations and actions are only provided as examples, and some of the operations and actions may be optional, combined into fewer operations and actions, or expanded into additional operations and actions without detracting from the essence of the disclosed example.

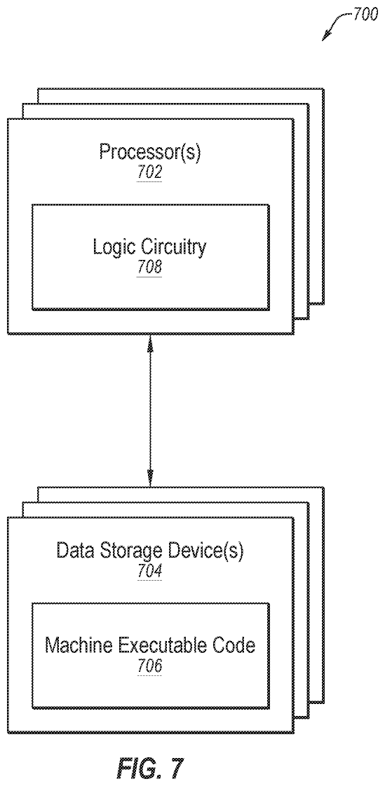

FIG. 7 is a block diagram illustrating an device 700 that, in various examples, may be used to implement various functions, operations, acts, processes, and/or methods disclosed herein. Device 700 includes one or more processors 702 (sometimes referred to herein as “processors 702”) operably coupled to one or more apparatuses such as data storage devices (sometimes referred to herein as “storage 704”), without limitation. Storage 704 includes machine executable code 706 stored thereon (e.g., stored on a computer-readable memory) and processors 702 include logic circuitry 708. Machine executable code 706 includes information describing functional elements that may be implemented by (e.g., performed by) logic circuitry 708. Logic circuitry 708 is adapted to implement (e.g., perform) the functional elements described by machine executable code 706. Device 700, when executing the functional elements described by machine executable code 706, should be considered as special purpose hardware configured for carrying out the functional elements disclosed herein. In various examples, processors 702 may be configured to perform the functional elements described by machine executable code 706 sequentially, concurrently (e.g., on one or more different hardware platforms), or in one or more parallel process streams.

When implemented by logic circuitry 708 of processors 702, machine executable code 706 is configured to adapt processors 702 to perform operations of examples disclosed herein. For example, machine executable code 706 may be configured to adapt processors 702 to perform at least a portion or a totality of method 500 of FIG. 5 or method steps 600 of FIG. 6. As another example, machine executable code 706 may be configured to adapt processors 702 to perform at least a portion or a totality of the operations discussed for apparatus 100 of FIG. 1, system 200 of FIG. 2, system 300 of FIG. 3, system 400 of FIG. 4, system 800 of FIG. 8, and more specifically, one or more of detector 102 of FIG. 1, detector 202 of FIG. 2, timing-signal generator 214 of FIG. 2, virtual-time-source generator 224 of FIG. 2, detector 302 of FIG. 3, receiver 314 of FIG. 3, detector 402 of FIG. 4, receiver 414 of FIG. 4, network-connected device 418 of FIG. 4, detectors 802 of FIG. 8 or analyzer 816 of FIG. 8.

Processors 702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute computing instructions (e.g., software code) related to examples of the present disclosure. It is noted that a general-purpose processor (may also be referred to herein as a host processor or simply a host) may be a microprocessor, but in the alternative, processors 702 may include any conventional processor, controller, microcontroller, or state machine. Processors 702 may also be implemented as a combination of computing devices, such as a combination of a DSP and a microprocessor, a plurality of microprocessors, one or more microprocessors in conjunction with a DSP core, or any other such configuration.

In various examples, storage 704 includes volatile data storage (e.g., random-access memory (RAM)), non-volatile data storage (e.g., Flash memory, a hard disc drive, a solid state drive, erasable programmable read-only memory (EPROM), without limitation). In various examples, processors 702 and storage 704 may be implemented into a single device (e.g., a semiconductor device product, a system on chip (SOC), without limitation). In various examples, processors 702 and storage 704 may be implemented into separate devices.

In various examples, machine executable code 706 may include computer-readable instructions (e.g., software code, firmware code). By way of non-limiting example, the computer-readable instructions may be stored by storage 704, accessed directly by processors 702, and executed by processors 702 using at least logic circuitry 708. Also by way of non-limiting example, the computer-readable instructions may be stored on storage 704, transmitted to a memory device (not shown) for execution, and executed by processors 702 using at least logic circuitry 708. Accordingly, in various examples, logic circuitry 708 includes electrically configurable logic circuitry.

In various examples, machine executable code 706 may describe hardware (e.g., circuitry) to be implemented in logic circuitry 708 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in various examples, machine executable code 706 may include an HDL, an RTL, a GL description, a mask level description, other hardware description, or any combination thereof.

In examples where machine executable code 706 includes a hardware description (at any level of abstraction), a system (not shown, but including storage 704) may be configured to implement the hardware description described by machine executable code 706. By way of non-limiting example, processors 702 may include a programmable logic device (e.g., an FPGA or a PLC) and the logic circuitry 708 may be electrically controlled to implement circuitry corresponding to the hardware description into logic circuitry 708. Also by way of non-limiting example, logic circuitry 708 may include hard-wired logic manufactured by a manufacturing system (not shown, but including storage 704) according to the hardware description of machine executable code 706.

Regardless of whether machine executable code 706 includes computer-readable instructions or a hardware description, logic circuitry 708 is adapted to perform the functional elements described by machine executable code 706 when implementing the functional elements of machine executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In various examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” without limitation).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, without limitation” or “one or more of A, B, and C, without limitation.” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples of the disclosure may include:

Example 1: A method comprising: determining a relationship between a property of a position, navigation, and timing (PNT)-based timing signal and a property of a virtual time source. The method may additionally include determining a state of the PNT-based timing signal at least partially responsive to the determined relationship. The method may additionally include one or more of: providing the PNT-based timing signal at least partially responsive to determining that the state of the PNT-based timing signal corresponds to a first state, disregarding the PNT-based timing signal at least partially responsive to determining that the state of the timing signal corresponds to a second state, and providing an indication of the state of the PNT-based timing signal at least partially responsive to determining that the state of the timing signal corresponds to a second state.

Example 2: The method according to Example 1, comprising generating the virtual time source responsive to a network-transferred timing signal.

Example 3: The method according to any of Example 1 and 2, wherein the virtual time source is according to a network-based-timing protocol.

Example 4: The method according to any of Example 1 through 3, comprising generating the PNT-based timing signal responsive to a PNT signal.

Example 5: The method according to Example 4, comprising receiving the PNT signal from a source associated with a PNT service.

Example 6: The method according to Example 5, wherein the source is one of a global-positioning system (GPS) satellite or a global navigation satellite system (GNSS) satellite.

Example 7: The method according to any of Example 4 through 6, comprising determining a position responsive to the PNT signal.

Example 8: The method according to any of Example 1 through 7, wherein the determining the relationship comprises determining an alignment between the property of the PNT-based timing signal and the property of the virtual time source.

Example 9: The method according to any of Example 1 through 8, wherein the determining the relationship comprises determining a temporal correspondence between a top of second of the PNT-based timing signal and a corresponding top of second of the virtual time source.

Example 10: The method according to any of Example 1 through 9, wherein determining the state of the PNT-based timing signal comprises determining whether a top of second of the PNT-based timing signal is within a threshold duration from a top of second of the virtual time source.

Example 11: The method according to any of Example 1 through 10, the process comprising providing an indication that the PNT-based timing signal is invalid at least partially responsive to determining that the state of the timing signal corresponds to the second state.

Example 12: An apparatus, comprising a detector to detect a presence of an anomaly in a position, navigation, and timing (PNT) signal, wherein the detector senses a difference between a top of second of a virtual time source and a top of second of a PNT-based timing signal.

Example 13: The method according to Example 12, wherein the top of second of the virtual time source is indicative of a beginning of a second according to Universal Coordinated Time (UTC).

Example 14: The method according to any of Example 12 and 13, wherein the apparatus is to obtain a timing signal indicative of the top of second of the virtual time source. Wherein the apparatus is additionally to generate, at least partially responsive to the PNT signal, a PNT-based timing signal indicative of the top of second according to the PNT signal. Wherein the apparatus is additionally to compare the timing signal to the PNT-based timing signal.

Example 15: The method according to any of Example 12 through 14, wherein the PNT signal is received from one of a global-positioning system (GPS) satellite or a global navigation satellite system (GNSS) satellite.

Example 16: The method according to any of Example 12 through 15, wherein the virtual time source is generated responsive to a network-transferred timing signal.

Example 17: A system, comprising a receiver to generate a position, navigation, and timing (PNT)-based timing signal at least partially responsive to a PNT signal. The system additionally comprising a detector to determine a relationship between a property of the PNT-based timing signal and a property of a virtual time source. The detector may be to additionally determine a state of the PNT-based timing signal at least partially responsive to the determined relationship. The detector may be to additionally one or more of: provide the PNT-based timing signal at least partially responsive to determining that the state of the timing signal corresponds to a first state, disregard the PNT-based timing signal at least partially responsive to determining that the state of the PNT-based timing signal corresponds to a second state, and provide an indication of the state of the PNT-based timing signal responsive to determining that the state of the PNT-based timing signal corresponds to a second state.

Example 18: The method according to Example 16, comprising a network-connected device to generate the virtual time source responsive to a network-transferred timing signal.

Example 19: The method according to any of Example 17 and 18, wherein the receiver is to receive the PNT signal from a source associated with a PNT service.

Example 20: The method according to any of Example 17 through 19, wherein the receiver is to determine a position at least partially responsive to the PNT signal.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method comprising:
determining a relationship between a property of a position, navigation, and timing (PNT)-based timing signal and a property of a virtual time source;
determining a state of the PNT-based timing signal at least partially responsive to the determined relationship; and
one or more of:
providing the PNT-based timing signal at least partially responsive to determining that the state of the PNT-based timing signal corresponds to a first state;
disregarding the PNT-based timing signal at least partially responsive to determining that the state of the PNT-based timing signal corresponds to a second state; and
providing an indication of the state of the PNT-based timing signal at least partially responsive to determining that the state of the PNT-based timing signal corresponds to a second state.

2. The method of claim 1, comprising generating the virtual time source responsive to a network-transferred timing signal.

3. The method of claim 1, wherein the virtual time source is according to a network-based-timing protocol.

4. The method of claim 1, comprising generating the PNT-based timing signal responsive to a PNT signal.

5. The method of claim 4, comprising receiving the PNT signal from a source associated with a PNT service.

6. The method of claim 5, wherein the source is one of a global-positioning system (GPS) satellite or a global navigation satellite system (GNSS) satellite.

7. The method of claim 4, comprising determining a position responsive to the PNT signal.

8. The method of claim 1, wherein the determining the relationship comprises determining an alignment between the property of the PNT-based timing signal and the property of the virtual time source.

9. The method of claim 1, wherein the determining the relationship comprises determining a temporal correspondence between a top of second of the PNT-based timing signal and a corresponding top of second of the virtual time source.

10. The method of claim 1, wherein determining the state of the PNT-based timing signal comprises determining whether a top of second of the PNT-based timing signal is within a threshold duration from a top of second of the virtual time source.

11. The method of claim 1, the method comprising providing an indication that the PNT-based timing signal is invalid at least partially responsive to determining that the state of the PNT-based timing signal corresponds to the second state.

12. An apparatus, comprising a detector to detect a presence of an anomaly in a position, navigation, and timing (PNT) signal, wherein the detector senses a difference between a top of second of a virtual time source and a top of second of a PNT-based timing signal.

13. The apparatus of claim 12, wherein the top of second of the virtual time source is indicative of a beginning of a second according to Universal Coordinated Time (UTC).

14. The apparatus of claim 12, wherein the apparatus is to:
obtain a timing signal indicative of the top of second of the virtual time source;
generate, at least partially responsive to the PNT signal, a PNT-based timing signal indicative of the top of second according to the PNT signal; and
compare the timing signal to the PNT-based timing signal.

15. The apparatus of claim 12, wherein the PNT signal is received from one of a global-positioning system (GPS) satellite or a global navigation satellite system (GNSS) satellite.

16. The apparatus of claim 12, wherein the virtual time source is generated responsive to a network-transferred timing signal.

17. A system comprising:
a receiver to generate a position, navigation, and timing (PNT)-based timing signal at least partially responsive to a PNT signal;
a detector to:
determine a relationship between a property of the PNT-based timing signal and a property of a virtual time source;
determine a state of the PNT-based timing signal at least partially responsive to the determined relationship; and
one or more of:
provide the PNT-based timing signal at least partially responsive to determining that the state of the PNT-based timing signal corresponds to a first state;
disregard the PNT-based timing signal at least partially responsive to determining that the state of the PNT-based timing signal corresponds to a second state; and
provide an indication of the state of the PNT-based timing signal responsive to determining that the state of the PNT-based timing signal corresponds to a second state.

18. The system of claim 17, comprising a network-connected device to generate the virtual time source responsive to a network-transferred timing signal.

19. The system of claim 17, wherein the receiver is to receive the PNT signal from a source associated with a PNT service.

20. The system of claim 17, wherein the receiver is to determine a position at least partially responsive to the PNT signal.
